(19) United States
(12) Patent Application Publication
(10) Pub. No.: US 2019/0029918 A1
(43) Pub. Date: Jan. 31, 2019

(54) MASSAGE MACHINE SYSTEM, MASSAGE MACHINE USED THEREIN, AND WEARABLE MEASUREMENT INSTRUMENT USED THEREIN

(71) Applicant: FAMILY INADA CO., LTD., Osaka (JP)

(72) Inventors: Nichimu Inada, Osaka (JP); Yuta Ishidou, Tottori (JP)

(21) Appl. No.: 16/045,361

(22) Filed: Jul. 25, 2018

(30) Foreign Application Priority Data
Jul. 26, 2017 (JP) 2017-144968

(51) Int. Cl. A61H 23/02; A61H 15/00; A61H 7/00

(52) U.S. Cl. CPC A61H 23/0254; A61H 15/0078; A61H 7/007; A61H 2205/106; A61H 2201/1669; A61H 2205/081; A61H 2205/062; A61H 2201/0149

(57) ABSTRACT

A massage machine system includes a massage machine, a wearable measurement instrument, a server and an electronic information communication terminal. The massage machine includes a massage unit configured to massage a body of a user and a control unit configured to control the massage unit. The wearable measurement instrument includes a detection unit and a transmission unit. The detection unit is configured to detect physical information of the user. The transmission unit is configured to transmit the physical information detected by the detection unit. The server is configured to store the physical information transmitted by the wearable measurement instrument and received by the server.

### RELATED APPLICATION

The application claims a benefit of priority under the Paris Convention based on Japanese Patent Application No. 2017-144968 filed on Jul. 26, 2017, the contents of which, including the specification, the claims and drawings, are incorporated herein by reference in their entirety.

### TECHNICAL FIELD

The present invention relates to a massage machine system including a massage machine for massaging a user, and a massage machine and a wearable measurement instrument which are used therein, and particularly relates to a massage machine which can perform proper massage by using physical information such as a pulse rate or a step count acquired by a wearable measurement instrument.

### BACKGROUND ART

A chair type or mattress type massage machine is widely known. For example, the chair type massage machine has a seat unit and a backrest unit and employs a structure in which a treatment unit for performing massage is disposed in the backrest unit. Then, a plurality of built-in motors are driven in combination with each other. In this manner, the treatment unit can selectively perform a plurality of operations (for example, a kneading operation, a patting operation, and changing a treatment target site). The massage machine which can perform the plurality of operations in this way has a controller and is operated by a user using the controller. In this manner, the user selects a massage course (a relaxation course, a stress relief course, or a professional course) corresponding to a predetermined combination of movements of the treatment unit and pressure applying operations.

Incidentally, a type of the massage course suitable for the user varies depending on a health condition of the user. Therefore, a massage machine has been proposed which includes a detection device for measuring biological information such as a heart rate, a blood pressure value, a body temperature, and a galvanic skin reflex of the user so as to select the massage course, based on the measured biological information (for example, refer to Japanese Patent Application Publication Nos. H9-192186 and 2000-070373).

### SUMMARY OF THE INVENTION

This invention relates to a massage machine system that includes a massage machine, a wearable measurement instrument, a server and an electronic information communication terminal. The massage machine includes a massage unit configured to massage a body of a user and a a control unit or a control circuit configured to control the massage unit. The wearable measurement instrument includes a detection sensor or a detection unit and a a transmission unit or a transmission circuit. The detection sensor or the detection unit is configured to detect physical information of the user. The transmission unit or the transmission circuit is configured to transmit the physical information detected by the detection sensor or the detection unit. The server is configured to store the physical information transmitted by the wearable measurement instrument and received by the server.

The server is electronically connected to the massage machine and the electronic information communication terminal. The electronic information communication terminal includes a receiving unit or a receiving circuit that is configured to electronically receive the physical information transmitted by the wearable measurement instrument.

### BRIEF DESCRIPTION OF THE DRAWINGS

FIG. 1 is a conceptual diagram illustrating a configuration of a massage machine system according to an embodiment of the present invention.

FIG. 2 is a conceptual diagram illustrating the configuration of the massage machine system according to the embodiment of the present invention.

FIG. 3 is a perspective view of a massage machine according to the embodiment of the present invention.

FIG. 4 is a block diagram illustrating a configuration of the massage machine.

FIG. 5 is a block diagram illustrating a configuration of a smartphone.

FIG. 6 illustrates an example of an advice display screen displayed on a display.

FIG. 7 illustrates an example of a massage course information screen displayed on the display.

FIG. 8 is a conceptual diagram illustrating a configuration of the massage machine system according to the embodiment of the present invention.

FIG. 9 is a conceptual diagram illustrating a configuration of a massage machine system according to another embodiment of the present invention.

FIG. 10 is a conceptual diagram illustrating a configuration of a massage machine system according to still another embodiment of the present invention.

FIG. 11 is a conceptual diagram illustrating a configuration of a massage machine system according to still another embodiment of the present invention.

### DESCRIPTION OF THE INVENTION

Hereinafter, embodiments according to the present invention will be described with reference to the drawings.

### <Massage Machine System>

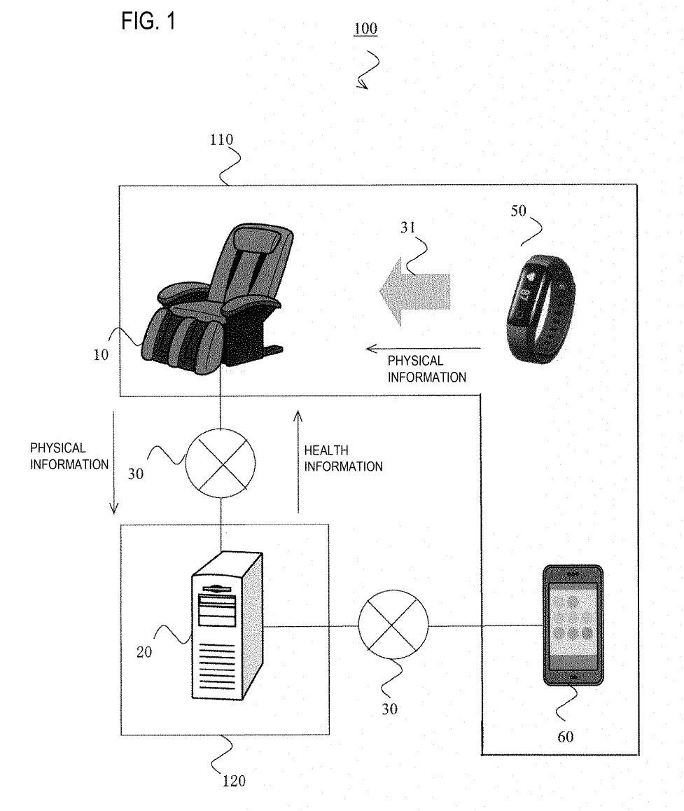

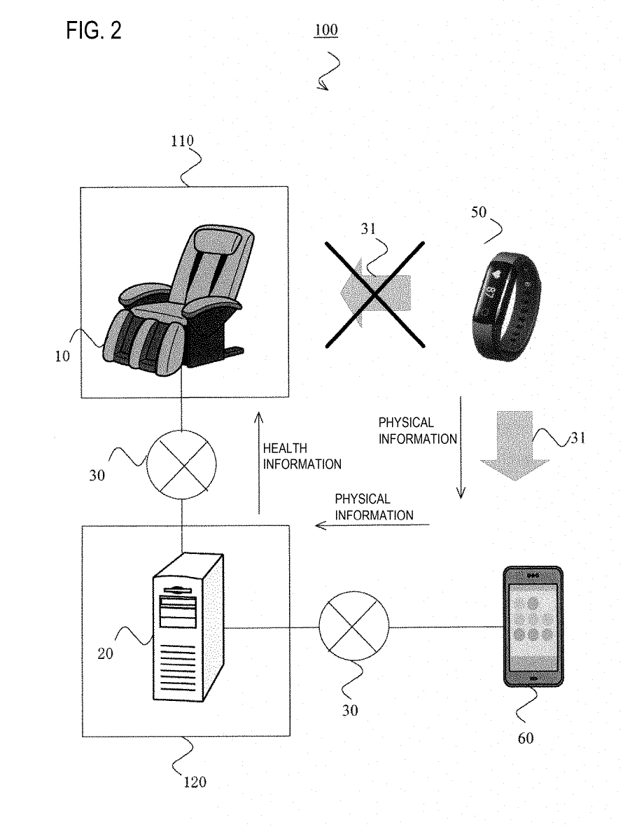

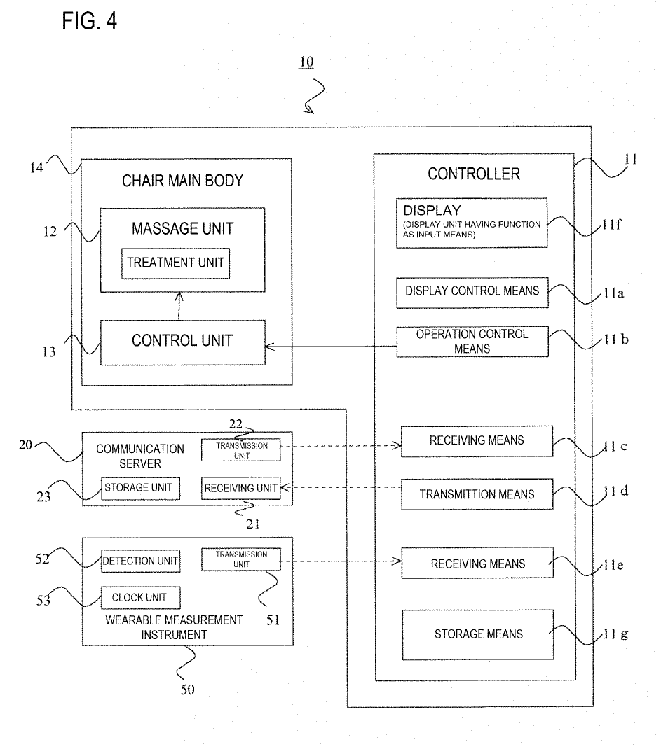

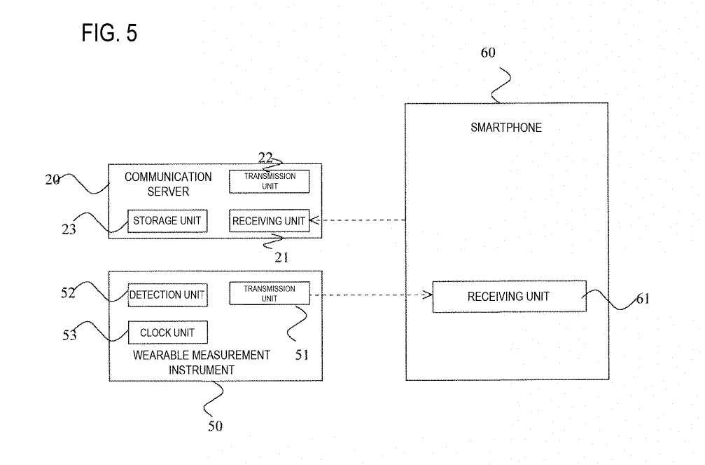

FIGS. 1 and 2 are conceptual diagrams illustrating a configuration of a massage machine system according to an embodiment of the present invention. FIG. 1 is a diagram when a user is at home (distance between a wearable measurement instrument and a massage machine is 10 meters or shorter), and FIG. 2 is a diagram when the user goes out (distance between the wearable measurement instrument and the massage machine is 10 meters or longer). In addition, FIG. 4 is a block diagram illustrating a configuration of a massage machine (10), and FIG. 5 is a block diagram illustrating a configuration of a smartphone (60) serving as an electronic information communication terminal.

A massage machine system (100) includes a massage machine (10) installed at a home (110) of a user P, a cloud-type communication server (20) installed in a business operator (120), a wearable measurement instrument (50) carried by the user P, and the smartphone (60) serving as the electronic information communication terminal.

In the present embodiment, a case will be described where the smartphone (60) having a receiving unit or receiving circuit (61) for wireless communication is used as the electronic information communication terminal. However, the present invention is not limited thereto, and a tablet terminal device may be used.

For example, the business operator includes a business operator who lends the massage machine (10), a business operator who manages the sold massage machine (10), and a hospital (medical institution). It is desirable that the hospital and the business operator cooperate with each other in order to prepare health information (to be described later).

A controller (11) of the massage machine (10) and the communication server (20) can be connected to each other using a public network (hereinafter, referred to as a “communication network”) (30). The communication server (20) and the smartphone (60) can be connected to each other using the communication network (30).

For example, the communication network includes an internet network and a local network.

A transmission unit or circuit (51) of the wearable measurement instrument (50) and a receiving unit (11e) of the massage machine (10) can be connected to each other by wireless communication (31), and the transmission unit (51) of the wearable measurement instrument (50) and the receiving unit (61) of the smartphone (60) can be connected to each other by wireless communication (31).

As the above-described wireless communication, it is preferable that communication is available within a communicable distance (for example, within 10 meters). For example, the wireless communication includes the Bluetooth (registered trademark), a wireless local area network (LAN), and infrared data association (IrDA).

### <Wearable Measurement Instrument>

The wearable measurement instrument (50) can be worn on the body of the user P. For example, the wearable measurement instrument (50) includes a wearable watch equipped with a measurement instrument, which can be worn on a wrist of the user P, or a headgear equipped with a measurement instrument, which can be worn on a head of the user P.

The wearable measurement instrument (50) includes a detection unit or a detection sensor (52) which detects physical information, the receiving unit or receiving circuit (11e) or the transmission unit (51) capable of communicating with the receiving unit (61) of the smartphone (60) by the wireless communication (31), and a clock unit (53).

For example, the physical information detected by the detection unit (52) includes a pulse rate, a step count, a walking distance, a blood pressure, a body temperature, a sweat rate, a blood glucose level, calorie consumption, a sleep state, a body weight, a body fat percentage, moisture content, muscle mass, bone mass, a basal metabolic rate, BMI, and a obesity index.

The clock unit or circuit (53) is configured to be able to clock the time, and the user P can set a measurement timing (for example, a measurement time).

The transmission unit (51) communicates with the receiving unit (11e) of the massage machine (10) or the receiving unit (61) of the smartphone (60). As illustrated in FIG. 1, if the massage machine (10) is located within the communicable distance, the physical information is output to the receiving unit (11e) of the massage machine (10). However, if the massage machine (10) is located outside the communicable distance, the physical information cannot be output to the receiving unit (11e) of the massage machine (10). Therefore, if the massage machine (10) does not exist within the communicable distance as illustrated in FIG. 2, the physical information is output to the receiving unit (61) of the smartphone (60) carried by the user P.

The transmission unit (51) outputs the physical information to the receiving unit (61) of the smartphone (60) if the smartphone (60) is located within the communicable distance. However, if the smartphone (60) is located outside the communicable distance, the physical information cannot be output to the receiving unit (61) of the smartphone (60). However, when the user P goes out, the smartphone (60) is carried by the user P in many cases. Therefore, the smartphone (60) is located within the communicable distance (for example, within 10 meters).

In the wearable measurement instrument (50) configured in this way, even if the user P exercises or sleeps, the physical information can be detected at the measurement time, merely by wearing the wearable measurement instrument on the body of the user P. If the smartphone (60) and the massage machine (10) are located within the communicable distance, the physical information is output to the massage machine (10). In addition, if the massage machine (10) is located outside the communicable distance, the physical information is output to the smartphone (60) carried by the user P. Furthermore, if only the massage machine (10) is located within the communicable distance, the physical information is output to the massage machine (10).

### <Communication Server>

The communication server (20) is a cloud-type communication server installed in the business operator (120).

The communication server (20) and the controller (11) of the massage machine (10) can be connected to each other by the communication network (30). The communication server (20) and the smartphone (60) can be connected to each other by the communication network (30). The communication server (20) includes a receiving unit or receiving circuit (21) which receives electronic data from the smartphone (60) or the controller (11), a transmission unit or circuit (22) which transmits the electronic data to the controller (11), and a storage unit or circuit (23).

In this manner, as the electronic data (for example, an E-mail), the communication server (20) receives the physical information detected by the wearable measurement instrument (50) by way of the controller (11) or the smartphone (60). That is, when the wearable measurement instrument (50) outputs the physical information to the massage machine (10), the physical information is received by way of the controller (11). When the wearable measurement instrument (50) outputs the physical information to the smartphone (60), the physical information is received by way of the smartphone (60). As a result, the physical information of the user P at the measurement time is received.

The storage unit (23) stores the physical information, and the physical information received from the smartphone (60) or the controller (11) by the receiving unit (21) is stored therein together with the date and time. That is, according to the present embodiment, the physical information is accumulated and searched for in a time-dependent manner, that is, a so-called database is established.

In this way, based on the physical information stored in the storage unit (23), the health information is prepared by the communication server (20). For example, the health information includes an advice based on big data, a proper massage course, and a doctor's advice. For example, a doctor, an examination technician, or a person of a business operator performs determination such as comparison between the past physical information and the current physical information. Thereafter, in a case where it is considered that a kidney function of the user P is poor, as the health information, an advice is prepared by the doctor, and information relating to the massage course is prepared by the person of the business operator (for example, “The massage suitable for a person whose kidney function is not active is recommended to receive a course for mainly massaging triple burner meridian (SJ-5)→spleen meridian (SP-6)→bladder meridian (BL-23). The triple burner meridian (SJ-5) is an acupuncture point on the wrist, and it is expected that the point has an effect to wake up the body. The spleen meridian (SP-6) is an acupuncture point inside the ankle, and it is expected that the point improves a moisture flow. The bladder meridian (BL-23) is an acupuncture point on the waist. It is expected that the point has an effect to treat a kidney disease. In addition, you may stimulate bladder meridian (BL-10) which is supposed to have an effect to relieve the tiredness showing a representative symptom of the kidney. A recommendable course is fatigue recovery course”.

The transmission unit (22) performs control so as to transmit the health information as the electronic data (for example, the E-mail) to the controller (11). In this manner, as will be described later, when receiving the massage from the massage machine (10) at a later date, the user P can select a proper massage course by confirming the health information.

In the present embodiment, an example has been described in which the E-mail is exchanged as “information” exchange between the communication server (20) and the controller (11) or the smartphone (60). However, without being limited thereto, the information exchange may be made using an alternative method.

### <Massage Machine>

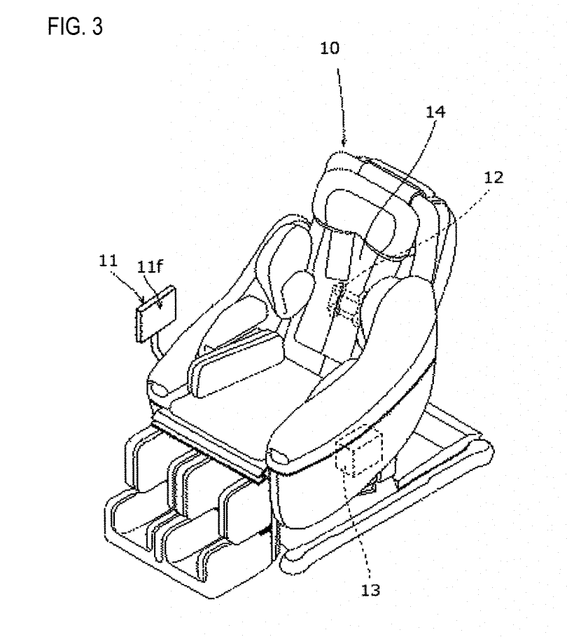

FIG. 3 is a perspective view of the massage machine according to the embodiment of the present invention. The massage machine (10) is configured to mainly include a chair main body (14) provided with a seat unit, a backrest unit, a footrest, and an armrest, a massage unit (12) provided with a motor and a treatment unit, a control unit or control circuit (13) which controls the massage unit (12), and a controller (11) which receives various operation inputs relating to massage operations.

For example, the massage unit (12) is built in the backrest unit, and is provided with the treatment unit driven by the motor. The massage unit (12) is configured so that an operation position (vertical position or width position) of the treatment unit, and operation speed and a displacement amount of the treatment unit can be changed.

The control unit (13) is configured to include a CPU, a RAM, a ROM, and a memory, and receives an instruction signal from operation control means or circuit (11b) of the controller (11) when the massage is performed. Based on the instruction signal, the control unit (13) outputs a control signal so as to operate the motor and to perform the massage using the treatment unit.

The controller (11) for outputting the instruction signal to the control unit (13) is configured to include the CPU, the RAM, the ROM, and the memory. The controller (11) has a display (display unit having a function as input means such as a touch panel) (11f), and is configured to be detachably disposed in a stand (not illustrated) on a side portion of the chair main body (14). Then, the controller (11) is connected to the control unit (13) by a signal line in a wired or wireless manner.

The storage means (11g) disposed in the controller (11) stores data relating to the massage course indicating operation patterns of the treatment unit, and stores a plurality of massage courses in advance. For example, the massage courses are used in order to perform a kneading operation, a patting operation, an acupressure operation, a rolling operation, a leg kneading operation, a pulling/kneading operation, a buttocks kneading operation, and an anus vibration operation at specified speed (without being limited to constant speed, the speed may be changed). The respective operations may be performed in combination with each other through a predetermined procedure (simultaneously or sequentially). As the massage courses, depending on the purpose of the massage, courses are prepared such as an edema relief course, a fatigue recovery course, a stress relief course, and a good night's sleep course.

For example, the “fatigue recovery course” is a massage technique which employs an idea of “massage” that is originated from ancient Europe, and which encourages blood flow from ends of the body toward the heart. Blood which is less likely to return to the heart is delivered again to the heart, fatigue recovery is encouraged, and metabolism is promoted so as to refresh the body. The “good night's sleep course” is a massage technique which employs an idea of so-called “Anma” that is originated from ancient China, and which encourages blood flow from the heart to the ends of the body. The whole blood circulation is promoted, and the blood is circulated to the ends of the body so as to provide relaxation. The massage course may include not only various operations of the massage unit (12) but also a combination of an operation for changing a reclining angle and an operation for changing a footrest angle.

Then, the controller (11) has display control means (11a) for displaying selectable massage courses or various types of information as an image on a display (11f), operation control means (11b) for receiving various operation inputs from the user P which includes operations based on the image displayed on the display (11f), and outputting an instruction signal to the control unit (13), receiving means (11c) for receiving the electronic data (for example, the E-mail) from the communication server (20), transmission means (11d) for transmitting the electronic data (for example, the E-mail) to the communication server (20), and a receiving unit (11e) to which the physical information is input from the wearable measurement instrument (50).

If the wearable measurement instrument (50) is located within the communicable distance, the receiving unit (11e) receives an input of the physical information detected by the wearable measurement instrument (50) at predetermined time intervals, and controls the storage means (11g) to store the physical information together with the date and time.

The transmission means (11d) performs control so as to transmit the physical information stored in the storage means (11g) as the electronic data (for example, the E-mail) to the communication server (20).

When the massage machine (10) is turned on, the receiving means (11c) receives the health information from the communication server (20) as the electronic data (for example, the E-mail), and controls the storage means (11g) to store the health information.

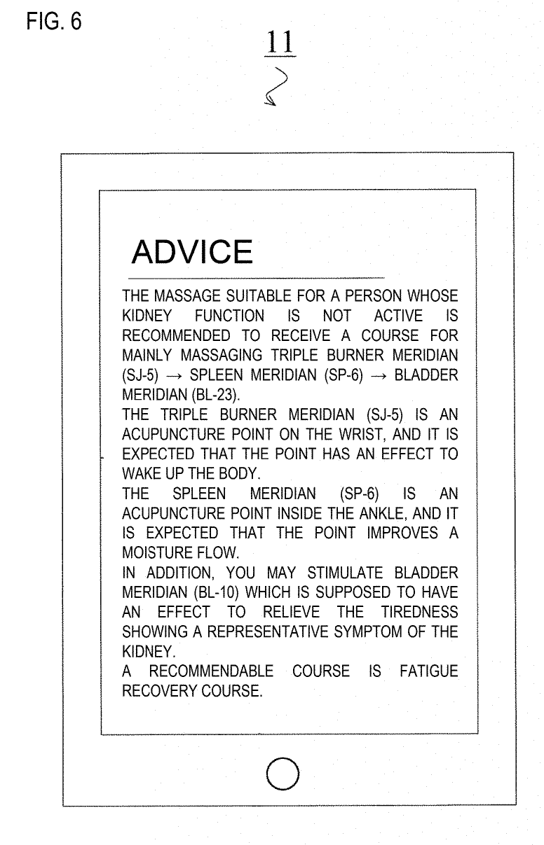

The display control means (11a) performs control so as to display a health condition of the user P on the display (11f) as an image (health condition checking function), or so as to automatically select and recommend a specific massage course, based on the health condition of the user P (massage course selecting function). For example, if the user P performs an operation in order to confirm the health condition by using the image displayed on the display (11f) before the user receives the massage, the display control means (11a) displays an advice for the health condition stored in the storage means (11g). FIG. 6 illustrates an example of an advice display screen displayed on the display (11f). The display (11f) displays a message prepared by a doctor. In this manner, in the massage machine (10) according to the present embodiment, the user P can recognize which selectable massage course is useful to the user P, and thus, can select the proper massage course. For example, the kidney function can be restored.

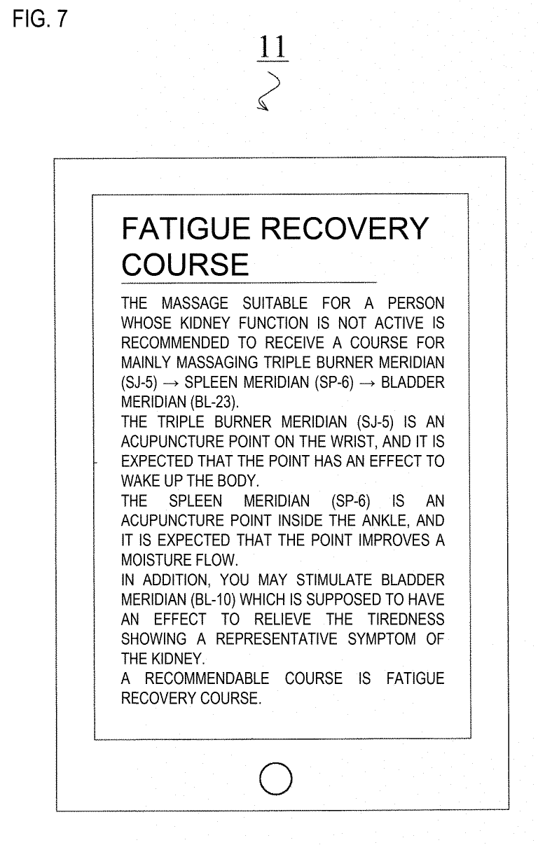

In addition, FIG. 7 illustrates an example of a massage course information screen displayed on the display. The display (11f) displays a message indicating “The massage suitable for a person whose kidney function is not active is recommended to receive a course for mainly massaging triple burner meridian (SJ-5)→spleen meridian (SP-6)→bladder meridian (BL-23). The triple burner meridian (SJ-5) is an acupuncture point on the wrist, and it is expected that the point has an effect to wake up the body. The spleen meridian (SP-6) is an acupuncture point inside the ankle, and it is expected that the point improves a moisture flow. In addition, you may stimulate bladder meridian (BL-10) which is supposed to have an effect to relieve the tiredness showing a representative symptom of the kidney. A recommendable course is fatigue recovery course”. In this manner, in the massage machine (10) according to the present embodiment, the user P can recognize that the fatigue recovery course is useful to the user P. For example, the kidney function can be restored. In this case, when the recommendable course such as the fatigue recovery course is not stored in the massage machine (10) of the user P, the user P may be provided with the recommendable course by the business operator (120), or may be offered to purchase the recommendable course.

In addition, in a case where a pulse rate is high as the acquired physical information, the massage machine (10) may determine that the body of the user P is not in a good state, and the massage machine (10) may select or recommend the proper massage course (for example, a centrifugal course for lowering the pulse). In this way, the user P can receive the proper massage course, based on the acquired physical information.

Furthermore, in a case where a stress value is high as the acquired physical information, the user P himself or herself may determine that the body of the user P is not in a good state, and the user P himself or herself may be able to select the massage course (for example, the stress relief treatment). In this way, the user P can receive the proper massage course, based on the acquired physical information.

As described above, according to the massage machine system (100) in the embodiment, for example, the user P can acquire the physical information during the user's exercise or sleep by using the wearable measurement instrument (50). Based on the acquired physical information, the user P can select the proper massage course when the user P receives the massage.

### Other Embodiments

(1) In the embodiment, a case has been described where the transmission unit (22) of the communication server (20) transmits the health information to only the controller (11) by using the E-mail. However, the embodiment is not limited thereto. When it is determined that the physical information is abnormal, a configuration may be adopted so that the communication server (20) transmits the E-mail to a second smartphone carried by a third party (child) P′.

In this way, in a case where the user P is an elderly person, the health condition of the user (parent) P can be confirmed using the second smartphone of the third party (child) P′ living in a place remote from the user P. Therefore, “monitoring” can be performed so that the remotely located third party (child) P′ confirms the health condition of the user (parent) P.

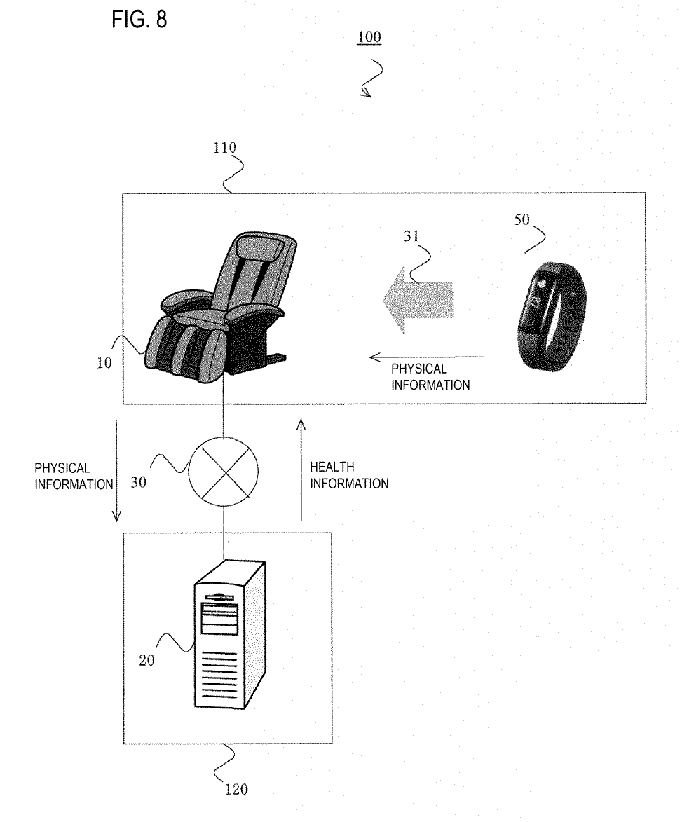

(2) In the embodiment, a case has been described where the massage machine system (100) includes the massage machine (10), the communication server (20), the wearable measurement instrument (50), and the smartphone (60). However, the massage machine system (100) may be configured to include the massage machine (10), the communication server (20), and the wearable measurement instrument (50). FIG. 8 is a conceptual diagram illustrating a configuration of a massage machine system according to an embodiment of the present invention. That is, the massage machine system (100) does not include the smartphone (60).

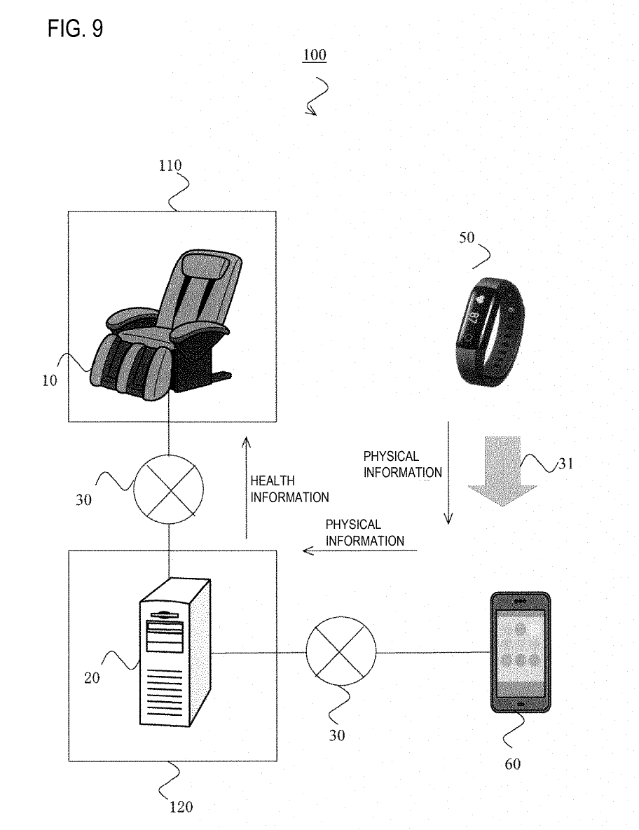

(3) In the embodiment, a case has been described where the massage machine (10) has the receiving unit (11e) to which the physical information is input from the wearable measurement instrument (50). However, the embodiment is not limited thereto. The massage machine (10) may be configured not to have the receiving unit (11e). FIG. 9 is a conceptual diagram illustrating a configuration of a massage machine system according to another embodiment of the present invention. That is, the physical information may always be received by way of the smartphone (60) and the communication server (20).

According to the massage machine system (100) configured in this way, the user P can also acquire the physical information during the user's exercise or sleep for 24 hours by using the wearable measurement instrument (50). Based on the acquired physical information, the user can select the proper massage course when the user receives the massage.

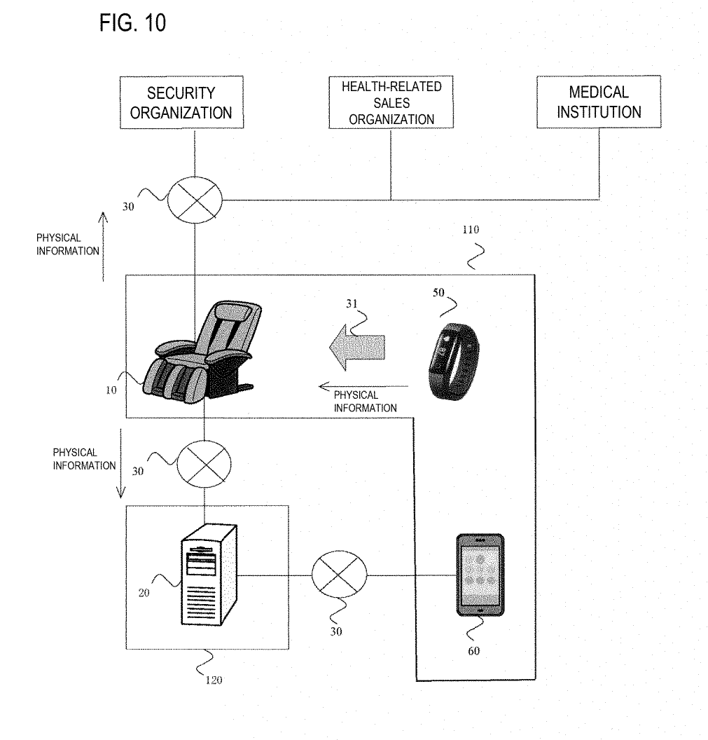

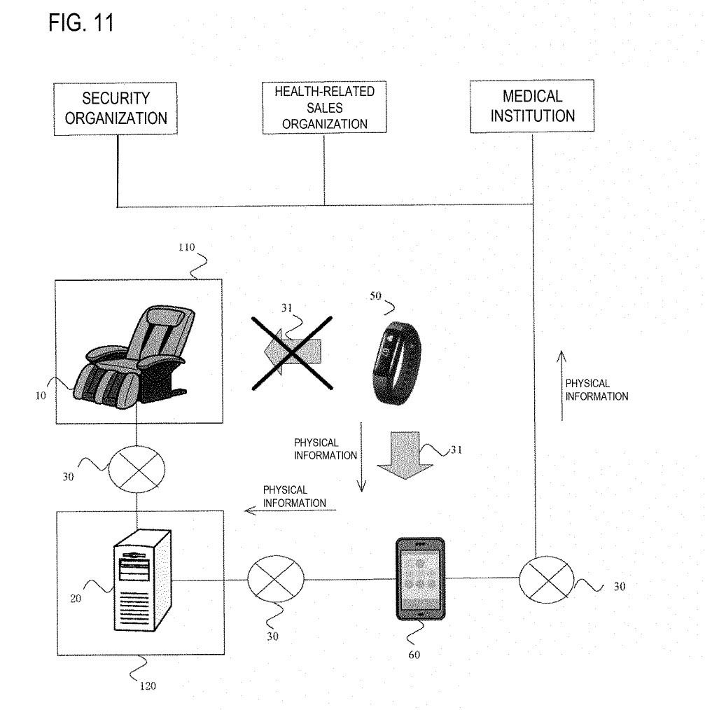

(4) In an embodiment, a configuration may be adopted so that the controller (11) of the massage machine (10) and/or the smartphone (60) and the security organization, the health-related sales organization, or the medical institution can be connected to each other by the communication network. FIGS. 10 and 11 are conceptual diagrams illustrating a configuration of a massage machine system according to another embodiment of the present invention. FIG. 10 is a diagram when the user is at home (distance between the wearable measurement instrument and the massage machine is within 10 meters). FIG. 11 is a diagram when the user goes out (distance between the wearable measurement instrument and the massage machine is 10 meters or longer).

What is claimed is:

1. A massage machine system comprising:
a massage machine that includes a massage unit configured to massage a body of a user and a control unit configured to control the massage unit;
a wearable measurement instrument including a detection unit and a transmission unit, the detection unit is configured to detect physical information of the user, the transmission unit is configured to transmit the physical information detected by the detection unit;
a server that is configured to store the physical information transmitted by the wearable measurement instrument and received by the server; and
an electronic information communication terminal,
wherein the server is electronically connected to the massage machine and the electronic information communication terminal and
wherein the electronic information communication terminal includes a receiving unit that is configured to electronically receive the physical information transmitted by the wearable measurement instrument.

2. The massage machine system according to claim 1,
wherein the massage machine includes a receiving unit configured to receive the physical information from the wearable measurement instrument,
wherein when the transmission unit of the wearable measurement instrument is located within a communicable distance with the receiving unit of the massage machine, the physical information is output to the receiving unit of the massage machine, and
wherein when the transmission unit of the wearable measurement instrument is located outside the communicable distance with the receiving unit of the massage machine, the physical information is output to the receiving unit of the electronic information communication terminal.

3. The massage machine system according to claim 2,
wherein the communicable distance is 10 meters.

4. A massage machine system comprising:
a massage machine that includes a massage unit configured to massage a body of a user and a control unit configured to control the massage unit;
a wearable measurement instrument including a detection unit configured to detect physical information of the user and a transmission unit configured to transmit the physical information detected by the detection unit; and
a server configured to store the physical information detected by the wearable measurement instrument,
wherein the server is electronically connected to the massage machine, and
wherein the massage machine includes a receiving unit configured to receive the physical information transmitted by the wearable measurement instrument.

5. The massage machine system according to claim 1,
wherein at least one of the massage machine and the electronic information communication terminal is configured to transmit the received physical information to the server, and
wherein the server is configured to prepare health information, based on the physical information, and configured to transmit the health information to the massage machine.

6. The massage machine system according to claim 5,
wherein the server is configured to prepare the health information, based on the stored physical information.

7. The massage machine system according to claim 5,
wherein the health information includes an advice for at least one of a disease and a lifestyle habit.

8. The massage machine system according to claim 1,
wherein the physical information represents at least one type of information selected from the group consisting of a pulse rate, a step count, a walking distance, a blood pressure, a body temperature, a sweat rate, a blood glucose level, calorie consumption, a sleep state, a body weight, a body fat percentage, moisture content, muscle mass, bone mass, a basal metabolic rate, BMI, and an obesity index.

9. The massage machine system according to claim 1, further comprising:
a second electronic information communication terminal,
wherein the second electronic information communication terminal and the server are electronically connected, and
wherein the second electronic information communication terminal receives the physical information.

10. The massage machine system according to claim 9,
Wherein, when it is determined that the physical information is abnormal, the server is configured to transmit abnormality information to the second electronic information communication terminal.

11. The massage machine system according to claim 1,
wherein the wearable measurement instrument includes a clock, and
wherein at a preset time of the clock, the detection unit is configured to detect the physical information of the user.

12. The massage machine system according to claim 1,
wherein at least one of the massage machine and the electronic information communication terminal is electronically connected to at least one of a security organization, a health-related sales organization, and a medical institution.

13. A massage machine used for the massage machine system according to claim 1,
wherein the massage machine is electronically connected to the server, and
wherein the physical information transmitted by the wearable measurement instrument is received by the receiving unit of the electronic information communication terminal.

14. A wearable measurement instrument used for the massage machine system according to claim 1 comprising:
the detection unit that is configured to detect the physical information; and
the transmission unit configured to communicate with the receiving unit of the electronic information communication terminal.
